(19) United States
(12) Patent Application Publication
(10) Pub. No.: US 2025/0376976 A1
(43) Pub. Date: Dec. 11, 2025

(54) ELECTROSPRAY THRUSTER SELF-PRESERVATION

(71) Applicant: The Regents of the University of Michigan, Ann Arbor, MI (US)

(72) Inventors: Benjamin Jorns, Ann Arbor, MI (US); Collin B. Whittaker, Ann Arbor, MI (US); Henry Sodano, Ann Arbor, MI (US)

(21) Appl. No.: 18/876,358

(22) PCT Filed: Jun. 19, 2023
(86) PCT No.: PCT/US2023/025669

§ 371 Date: Dec. 18, 2024

Related U.S. Application Data
(60) Provisional application No. 63/353,572, filed on Jun. 18, 2022.

(51) Int. Cl. F03H 1/00; H05H 1/54

(52) U.S. Cl. CPC F03H 1/0037; H05H 1/54

(57) ABSTRACT

An electrospray thruster includes an emitter including an array of tips, each tip of the array of tips being configured to emit ionic liquid, and an extractor electrode spaced from the emitter and comprising a conductive film, the conductive film having a plurality of apertures, the plurality of apertures being aligned with the array of tips of the emitter. The conductive film has a thickness such that an electrical short between the extractor electrode and the ionic fluid emitted from a respective tip of the array of tips ablates a portion of the conductive film along the aperture of the plurality of apertures aligned with the respective tip of the array of tips

### CROSS-REFERENCE TO RELATED APPLICATION

This application claims the benefit of U.S. provisional application entitled “Electrospray Thruster Self-Preservation,” filed Jun. 18, 2022, and assigned Ser. No. 63/353,572, the entire disclosure of which is hereby expressly incorporated by reference.

### BACKGROUND OF THE DISCLOSURE

### Field of the Disclosure

The disclosure relates generally to electrospray thrusters.

### Brief Description of Related Technology

Electrospray is a process in which a fluid meniscus subject to strong electric fields deforms into a sharp cone-like structure that sheds charge from its apex. Of its manifold applications, perhaps the most useful is its use as a form of electric propulsion, in which ionic liquid propellants offer several potential advantages over plasma-based technologies, such as Hall thrusters and ion thrusters, including, for instance, avoiding wall losses associated with operating at small scale. Correspondingly, electrospray thrusters can be manufactured at the microscale, providing capability for micro-propulsive applications. Indeed, the emission process itself occurs on a small enough scale that individual electrosprays exhibit greater thrust per unit area than virtually any other electric propulsion technology,

The major challenge with developing electrospray technology, however, is that the fundamental, thrust producing unit of these devices, an individual electrospray emitter (or emitter element), only produces force levels at the micro-Newton scale. In order to generate the acceleration necessary for maneuvering smallsat class spacecraft, electrospray thrusters must be multiplexed in large-scale arrays with thousands to millions of emitters operating concurrently. Each of these electrospray emitters in turn requires a strong electric field generated over tens to hundreds of micrometers of distance from an emitter tip to a downstream electrode. Slight misalignments due to tolerance errors in each emitter and its extracting electrode can give rise to arcing events, in which propellant deposition on the extractor electrode shorts the extractor electrode to the emitters, destroying the surface and leading to a cascade failure of the entire thruster circuit. The probability of these failures increases with the number of emitters.

A “flawless” system would lack inhomogeneity among emitters, and so each would fail simultaneously. But in a real system for which emitters can be manufactured and aligned within finite tolerance, emitter behavior accordingly varies. The practical consequence of this variability is that a small proportion of errant emitters can precipitously decrease expected device lifetimes as the number of emitters in parallel increases.

One approach to addressing this challenge involves electrically isolated emitters. Each emitter would be supplied power individually. While this approach would ensure that a localized short only disables a single emitter, this would also mean that an array would include as many power supplies as it has emitters, a prohibitive penalty in cases in which the number of emitters is scaled to produce a suitable amount of thrust.

### SUMMARY OF THE DISCLOSURE

In accordance with one aspect of the disclosure, an electrospray thruster includes an emitter comprising an array of tips, each tip of the array of tips being configured to emit ionic liquid, and an extractor electrode spaced from the emitter and including a conductive film, the conductive film having a plurality of apertures, the plurality of apertures being aligned with the array of tips of the emitter. The conductive film has a thickness such that an electrical short between the extractor electrode and the ionic fluid emitted from a respective tip of the array of tips ablates a portion of the conductive film along the aperture of the plurality of apertures aligned with the respective tip of the array of tips.

In connection with any one of the aforementioned aspects, the devices described herein may alternatively or additionally include or involve any combination of one or more of the following aspects or features. The electrospray thruster further includes a dielectric substance disposed between the emitter and the extractor electrode. The dielectric substance includes a gas. The dielectric substance includes a dielectric substrate that supports the conductive film, the dielectric substrate having a plurality of holes aligned with the plurality of apertures in the conductive film. The dielectric substrate is mounted on the emitter. Each hole of the plurality of holes in the dielectric substrate defines a respective sidewall disposed at a respective base of each tip of the array of tips. The dielectric substrate has a uniform thickness. The dielectric substrate has a thickness that matches a height of each tip of the array of tips. The dielectric substrate includes a ceramic material. The thickness of the conductive film falls in a range from about 8 nanometers (nm) to about 15 nm. The electrospray thruster further includes a power source coupled to the emitter and the extractor electrode, the power source being configured to apply a voltage to generate an electric field between the extractor electrode and the ionic fluid emitted from each tip of the array of tips. The conductive film has a resistivity, and the voltage is sufficient for ablation of the conductive film given the resistivity. The conductive film includes a metallic material. The conductive film includes silver. The conductive film includes gold.

### BRIEF DESCRIPTION OF THE DRAWING FIGURES

For a more complete understanding of the disclosure, reference should be made to the following detailed description and accompanying drawing figures, in which like reference numerals identify like elements in the figures.

FIG. 1 is a block diagram of an electrospray thruster having an extractor electrode configured for self-preservation of the electrospray thruster in the event of an arcing event in accordance with one example.

FIG. 2 depicts schematic views of an individual emitter tip of an electrospray thruster before and after an arcing event ablates a portion of a conductive film of the extractor electrode in accordance with one example.

FIG. 3 is a micrograph image of a plurality of apertures of an extractor electrode in accordance with one example.

FIG. 4 is an exploded, perspective view of an extractor electrode assembly in accordance with one example.

FIG. 5 depicts perspective, front and rear images of an extractor electrode assembly in accordance with one example.

The embodiments of the disclosed devices may assume various forms. Specific embodiments are illustrated in the drawing and hereafter described with the understanding that the disclosure is intended to be illustrative. The disclosure is not intended to limit the invention to the specific embodiments described and illustrated herein.

### DETAILED DESCRIPTION OF THE DISCLOSURE

Electrospray thrusters configured for self-preservation in the event of an arcing event are described. The disclosed thrusters include an extractor electrode with a conductive film configured for partial ablation in response to the arcing event. The partial ablation presents a mitigative solution to the challenge presented by electrospray thrusters having large emitter arrays. The solution provided by the disclosed thrusters is such that the failure of a single emitter (or emitter element) does not disable the entire array. The partial ablation provides a way in which individual emitters (or emitter elements) are removed from the circuit as they fail, allowing the remainder to continue to operate.

The mitigative solution of the disclosed thrusters is compatible with various types of emitter designs. As a result, the solution may be combined with designs or techniques directed to preventing or minimizing arcing events. For instance, the solution may be combined with emitter designs that are robust to the tolerances that give rise to the arcing events. Additional or alternative techniques for solving the problem of arcing may also be combined with the mitigative solution of the disclosed thrusters.

The self-preservation of the disclosed thrusters utilizes the current arising from the arcing event. If a short develops between the emitter element and the extractor electrode, the resulting current is sufficient to locally ablate the metallization of the extractor electrode, leaving a non-conducting area at the emitter element. Faulty emitters (or emitter elements) are thus deactivated, and thereby allowing the emitter array and thruster to continue operation.

The conductive film of the extractor electrode may be configured to ensure the local ablation and, in so doing, establish a resilient electrode. As described below, the conductive film may have a thickness such that an electrical short ablates a sufficient amount of the conductive film. One or more other parameters or characteristics of the conductive film may also be used to support the ablation, including, for instance, the composition and resistivity of the conductive film.

The components, construction, configuration, and other characteristics of the disclosed thrusters may lead to a thruster design having a flat aspect ratio. The flat aspect ratio allows for the thruster assembly to be conveniently integrated on existing spacecraft architectures. For instance, the thruster assembly may be mounted or otherwise installed on any flat, free surface of the spacecraft. The disclosed thrusters may thus effectively allow for a “slap-on” propulsion system.

Although described in connection with extractor electrodes spaced from an emitter by a dielectric substrate, the disclosed electrospray thrusters may use a wide variety of dielectric configurations and arrangements. For instance, in some cases, the extractor electrode may be spaced from the emitter by alternative or additional dielectric substances, such as air or another gas. The configuration of each emitter or emitter array may also vary. For instance, the emitters need not be cone-shaped. Alternatively or additionally, the profile or shape of each emitter may vary across the array. Such variance may arise from manufacturing tolerances and/or from one or more intentional design alterations.

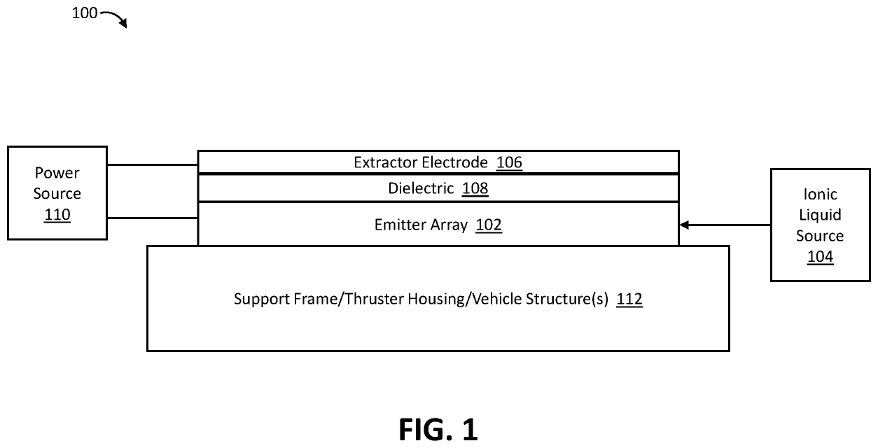

FIG. 1 depicts an electrospray thruster 100 in accordance with one example. The electrospray thruster 100 may provide thrust for a spacecraft, such as a satellite, or other vehicle. The thruster 100 includes an emitter (or emitter array) 102 coupled to a source 104 of a propellant, such as an ionic liquid. The emitter 102 includes an array of tips, each tip of the array of tips being configured to emit the ionic liquid. Electrosprays form at the ends of electrified menisci that form at the tips.

The components of the electrospray thruster 100 are schematically shown for ease in illustration, and are thus not to scale.

The source 104 of the ionic liquid is schematically shown in FIG. 1. A variety of reservoir configurations may be used, including both pressurized liquid pools and porous matrices from which the propellant is passively fed.

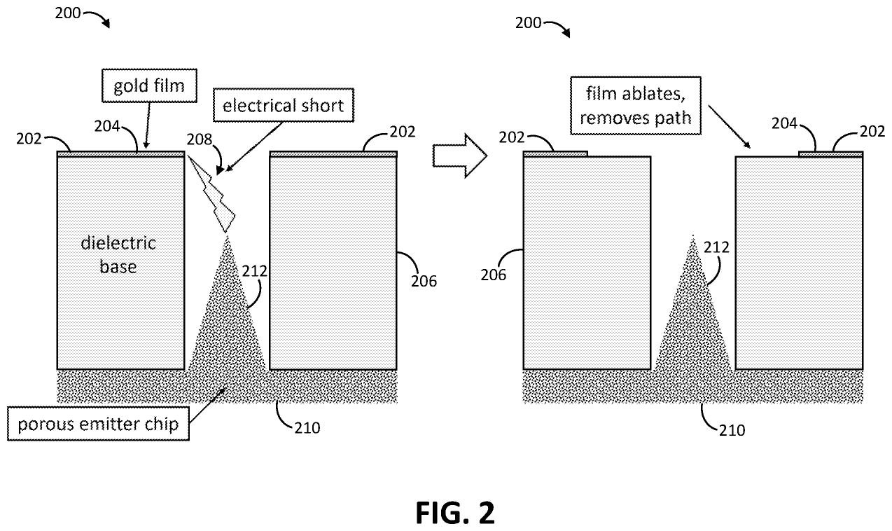

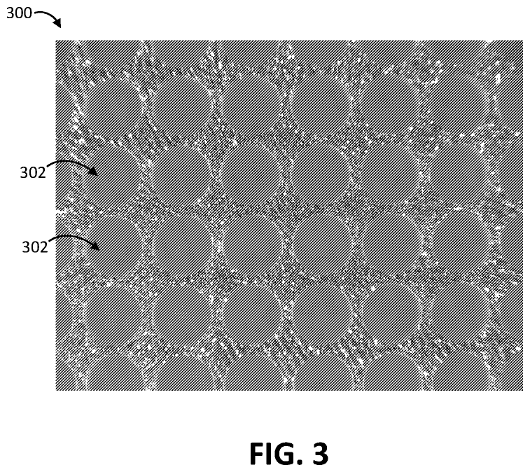

The electrospray thruster 100 also includes an extractor electrode 106 spaced from the emitter 102 by a dielectric substance or material 108. As described in connection with, for instance, FIGS. 2 and 3, the extractor electrode 106 includes a conductive film that has a plurality of apertures. The plurality of apertures are aligned with the array of tips of the emitter 102. As described herein, the conductive film has a thickness such that an electrical short between the extractor electrode 106 and the ionic fluid emitted from a respective tip of the array of tips ablates a portion of the conductive film at, near, or otherwise along the aperture aligned with the respective tip.

The thickness of the conductive film therefore provides a fault tolerance mechanism for the electrospray thruster 100. In the event of a short between the extractor electrode 106 and the element of the emitter 102, a current surge locally heats and ablates the conductive film, automatically removing the current path from the circuit.

The dielectric substance 108 may be integrated with the extractor electrode 106. For instance, in some cases, the dielectric substance 108 includes a dielectric substrate that supports the conductive film of the extractor electrode 106. The dielectric substrate may have a plurality of holes aligned with the plurality of apertures in the conductive film. In some cases, the dielectric substrate is mounted on the emitter 102.

The dielectric base or substrate may be a monolithic piece or unitary structure. This single-piece architecture guarantees alignment of the emitter 102 and the extractor electrode 106, which helps reduce the risk of arcing. In other cases, the dielectric substrate may be a composite structure. For example, the dielectric substance 108 may include multiple layers of dielectric materials or substances. In some cases, the multiple layers may include one or more solid layers (or other portions) and one or more gaseous layers (or other portions).

The configuration and construction of the dielectric substrate or base may also be useful as an alignment mechanism. The dielectric substrate may automatically align the extractor electrode 106 to the emitter array 102 (or emitter elements).

The dielectric substrate or other dielectric substance 108 may have a uniform thickness. In some cases, the dielectric substance 108 has a thickness that matches a height of each tip of the array of tips.

The dielectric substrate or other dielectric substance 108 may be composed of, or otherwise include, a ceramic material. Additional or alternative dielectric materials or substances may be used.

The thickness of the conductive film of the extractor electrode 106 may fall in a range from about 8 nanometers (nm) to about 15 nm. The term “about” is used herein to include deviations from a specified value that would be understood by one of ordinary skill in the art to effectively be the same as the specified value, including, for instance, deviations that do not result in a detectable or discernable change in outcome. Other deviations considered to be effectively be the same as the specified value may be based on, for instance, the absence of appreciable, detectable, or otherwise effective differences in operation, outcome, characteristic, or other aspect of the disclosed devices.

The electrospray thruster 100 may also include a power source 110 coupled to the emitter 102 and the extractor electrode 106. The power source 110 may be or include a DC voltage source. The power source 110 is configured to apply a voltage to generate an electric field between the extractor electrode 106 and the ionic fluid emitted from each tip of the emitter array 102. The voltage may be selected such that the voltage is sufficient for ablation of the conductive film of the extractor electrode 106 given the resistivity of the conductive film.

The electrospray thruster 100 may also include one or more support structures 112 configured to support one or more components of the electrospray thruster 100. For example, the electrospray thruster 100 may include a support frame to which the dielectric substance 108 and/or the extractor electrode 106 are mounted. Alternatively or additionally, the support structure(s) may be or include a housing of the electrospray thruster 100. Alternatively or additionally, one or more of the support structures 108 are components of the spacecraft or other vehicle carrying the electrospray thruster 100. For example, the support structure(s) 108 may be or include a chassis, frame, housing, or other structure of the vehicle.

FIG. 2 depicts the principle of operation for an electrospray thruster 200 having a resilient extractor electrode 202 in accordance with one example. The operation is depicted by showing a portion of the electrospray thruster 200 both before and after an electrical short event. In this case, a thin conductive or conducting film 202 of the extractor electrode 202 composed of, or otherwise including a metal, such as gold or silver, is deposited or otherwise disposed on a dielectric base 206 or other substrate or substance, providing an equipotential surface to generate the extraction field for an electrospray.

The dielectric base 206 has a number of apertures to accommodate an emitter 210. The emitter 210 includes an array of emitter elements 212, one of which is schematically shown in FIG. 2. Each emitter element 212 is disposed in a respective aperture of the dielectric base 206.

In the event that propellant causes a local electrical short (schematically and generally depicted at 208) between the extractor electrode 202 and the emitter 210, the large inrush of current resulting from the finite capacitance of the extractor electrode 202 and the emitter 210 deposits energy in the surrounding film 202 or grid, causing an ablation of the conducting film 202 and removing the current path. Thus, if arcing events do occur, the localized evaporation of the extractor electrode 202 prevents cascade failure of the thruster 200. Any problematic sites progressively remove themselves, leaving a still functional and highly capable thruster 200.

In the example of FIG. 2, the emitter 210 is or includes a porous emitter chip. The porous emitter chip, in turn, includes the array of emitter elements 212. In this case, each emitter element 212 is cone-shaped to define a tip. The shape, configuration, construction, composition, and/or other characteristics of the emitter 210 and emitter elements 212 may vary from the example shown.

Additionally, by constructing the dielectric base 206 to be of precise width (or depth or thickness), the longitudinal alignment (the tip-to-extractor distance) of the extractor electrode 202 and the emitter elements 212 is achieved automatically.

The dielectric base 206 may present additional alignment aids. For instance, the presence and/or positioning of the side walls of the dielectric base 206 may also assist in achieving a satisfactory lateral alignment (e.g., centering the emitter elements 212 to the apertures in the dielectric base 206).

In one example, the dielectric base 206 may be formed from a piece of MACOR® ceramic (Corning Inc.). The piece may be machined on a computer numerical control (CNC) mill to precision thickness to match the height of the emitter elements 212. For example, the thickness of the dielectric base 206 may be about 350 microns, but other thicknesses may be used. In this example, a thin layer of silver was deposited on the ceramic substrate using a DC magnetron sputterer. Additional or alternative metallization techniques may be used to form and define the conductive film 204 of the extractor electrode 202.

The conductive film 204 may be composed of, or otherwise include, a wide variety of metals and/or other conductive materials. For instance, the conductive film 204 may be composed of gold, silver, platinum, steel, or alloys (e.g., silver alloys) or other combinations thereof.

The grid of apertures may be machined through the dielectric base or substrate 206 and the conductive film 204 using a miniature drill. Additional or alternative processes may be used to form the apertures.

FIG. 3 depicts an image of an extractor grid 300 in accordance with one example. The extractor grid 300 was formed via drill-based machining. In one example, the center-to-center distance between adjacent apertures 302 is about 550 microns, but other distances may be used.

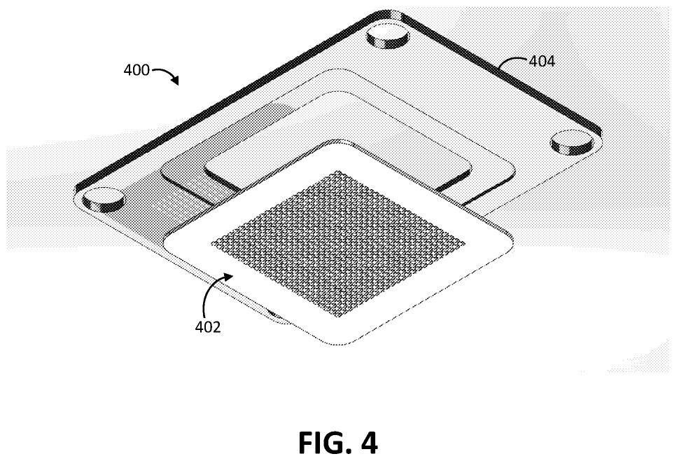

FIG. 4 depicts an extractor electrode assembly 400 in accordance with one example. The extractor electrode assembly 400 may include an extractor electrode 402. The extractor electrode 402 may or may not be integrated with a dielectric substrate. For instance, the dielectric substance may be alternatively or additionally provided separately from the extractor electrode 402 and/or extractor electrode assembly 400.

In this example, the extractor electrode assembly 400 includes a frame 404 to which the extractor electrode 402 is bonded (e.g., using conductive epoxy). The frame 404 may be composed of, or otherwise include, steel, but alternative or additional materials may be used. The frame 404 may be used for mounting within (or on) a thruster housing, vehicle housing, or other support structure.

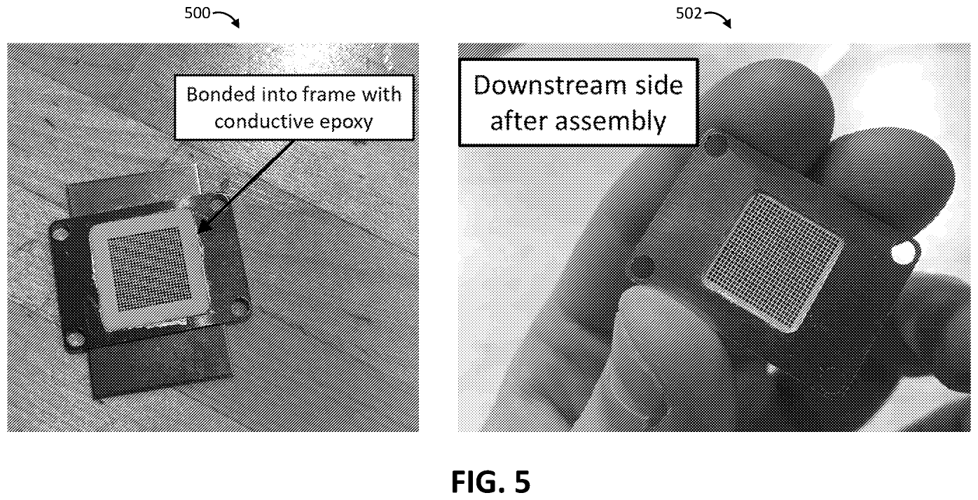

FIG. 5 includes images 500, 502 of an extractor electrode assembly having a frame in accordance with one example. The image 500 depicts the extractor electrode assembly after an extractor electrode has been bonded to the frame. The image 502 depicts the downstream side of the extractor electrode assembly. The extractor electrode assembly is being held in the image 502 to provide an indication of scale with the understanding that the size, shape, and other characteristics of the extractor electrode assembly may vary.

The present disclosure has been described with reference to specific examples that are intended to be illustrative only and not to be limiting of the disclosure. Changes, additions and/or deletions may be made to the examples without departing from the spirit and scope of the disclosure.

The foregoing description is given for clearness of understanding only, and no unnecessary limitations should be understood therefrom.

What is claimed is:

1. An electrospray thruster comprising:
an emitter comprising an array of tips, each tip of the array of tips being configured to emit ionic liquid; and
an extractor electrode spaced from the emitter and comprising a conductive film, the conductive film having a plurality of apertures, the plurality of apertures being aligned with the array of tips of the emitter;
wherein the conductive film has a thickness such that an electrical short between the extractor electrode and the ionic fluid emitted from a respective tip of the array of tips ablates a portion of the conductive film along the aperture of the plurality of apertures aligned with the respective tip of the array of tips.

2. The electrospray thruster of claim 1, further comprising a dielectric substance disposed between the emitter and the extractor electrode.

3. The electrospray thruster of claim 2, wherein the dielectric substance comprises a gas.

4. The electrospray thruster of claim 2, wherein the dielectric substance comprises a dielectric substrate that supports the conductive film, the dielectric substrate having a plurality of holes aligned with the plurality of apertures in the conductive film.

5. The electrospray thruster of claim 4, wherein the dielectric substrate is mounted on the emitter.

6. The electrospray thruster of claim 4, wherein each hole of the plurality of holes in the dielectric substrate defines a respective sidewall disposed at a respective base of each tip of the array of tips.

7. The electrospray thruster of claim 4, wherein the dielectric substrate has a uniform thickness.

8. The electrospray thruster of claim 4, wherein the dielectric substrate has a thickness that matches a height of each tip of the array of tips.

9. The electrospray thruster of claim 4, wherein the dielectric substrate comprises a ceramic material.

10. The electrospray thruster of claim 1, wherein the thickness of the conductive film falls in a range from about 8 nanometers (nm) to about 15 nm.

11. The electrospray thruster of claim 1, further comprising a power source coupled to the emitter and the extractor electrode, the power source being configured to apply a voltage to generate an electric field between the extractor electrode and the ionic fluid emitted from each tip of the array of tips, wherein:
the conductive film has a resistivity; and
the voltage is sufficient for ablation of the conductive film given the resistivity.

12. The electrospray thruster of claim 1, wherein the conductive film comprises a metallic material.

13. The electrospray thruster of claim 1, wherein the conductive film comprises silver.

14. The electrospray thruster of claim 1, wherein the conductive film comprises gold.
